(19) United States
(12) Patent Application Publication
(10) Pub. No.: US 2025/0335751 A1
(43) Pub. Date: Oct. 30, 2025

(54) Graphical User Interface (GUI) For Triggering The Application Of A Generative Artificial Intelligence (AI) Model To Generate Insight-Based Content In A User-Selected Target Region Of The GUI

(71) Applicant: Oracle International Corporation, Redwood Shores, CA (US)

(72) Inventors: David McColgin, Seattle, WA (US); Winston Leonard Wang, San Francisco, CA (US)

(73) Assignee: Oracle International Corporation, Redwood Shores, CA (US)

(21) Appl. No.: 18/802,226

(22) Filed: Aug. 13, 2024

Related U.S. Application Data
(60) Provisional application No. 63/638,600, filed on Apr. 25, 2024.

(51) Int. Cl. G06N 3/0475

(52) U.S. Cl. CPC G06N 3/0475

(57) ABSTRACT

Techniques for generating content using generative artificial intelligence (AI) are disclosed. A system detects a user interaction with a graphical user interface (GUI) to drag-and-drop an insight from one region of the GUI into another region of the GUI. Based on detecting the drag-and-drop action, the system identifies a set of underlying data associated with the insight. The system generates a prompt for a generative AI model based on a portion of the underlying data. The system presents content generated by the generative AI model in the region of the GUI into which the user dragged-and-dropped the insight.

### INCORPORATION BY REFERENCE; DISCLAIMER

Each of the following applications are hereby incorporated by reference: Application 63/638,600, filed Apr. 25, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to generating document content with generative artificial intelligence (AI). In particular, the present disclosure relates to a graphical user interface (GUI) that presents selectable insights related to displayed data in the GUI. A user action to drag-and-drop the insights into a target region of the GUI initiates content generation by generative AI in the target region.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for insight-based content generation with generative AI in accordance with one or more embodiments;

FIGS. 3A-3C illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CONTENT GENERATION ARCHITECTURE
3. APPLYING A GENERATIVE AI MODEL TO GENERATE CONTENT
4. EXAMPLE EMBODIMENT
5. PRACTICAL APPLICATIONS, ADVANTAGES, AND IMPROVEMENTS
6. COMPUTER NETWORKS AND CLOUD NETWORKS
7. HARDWARE OVERVIEW
8. MISCELLANEOUS; EXTENSIONS

### 1. GENERAL OVERVIEW

One or more embodiments generate and display content in a target region of a graphical user interface (GUI) (a) in response to detecting that an insight associated with a displayed data set has been dragged into the target region and (b) by inputting the dragged insight to a generative artificial intelligence (AI) model to generate the content. As used herein, an insight is a set of contextual data that is relevant to a data set displayed in a data display region of a GUI. Insights are obtained from data sources external to the data set, such as reports, articles, and other data files. The relevance of the insights to the data set may be determined by applying data in the dataset to a trained machine learning model or by applying a predefined set of rules. Examples of insights include data describing events associated with a data set, data describing entities associated with the data set, and data describing values included in the data set.

In an example, a system presents a GUI including a data display region displaying a data set, an insight presentation region displaying a set of insights, and a target region for displaying content generated by a generative AI model. When the system detects a user selection of a graphical representation of an insight, the system generates a prompt for a generative AI model that is based on the insight. For example, the system may detect a user drag and drop the graphical representation of the insight from the insight region into the target region. The prompt may be based further on metadata associated with the insight and/or the data set. The prompt may further be based on a user's personal history of interaction with the dataset, the user's interaction with other datasets, and other users' interactions with the dataset. The system inputs the prompt to the generative AI model for the generative AI model to generate content. The system presents the content in the target region. The content may include text paragraphs, diagrams, and graphics that are associated with the insight. The content may include additional information to further explain the insight.

One or more embodiments described in this Specification and/or recited in the claims may not be included in this General Overview section.

### 2. CONTENT GENERATION ARCHITECTURE

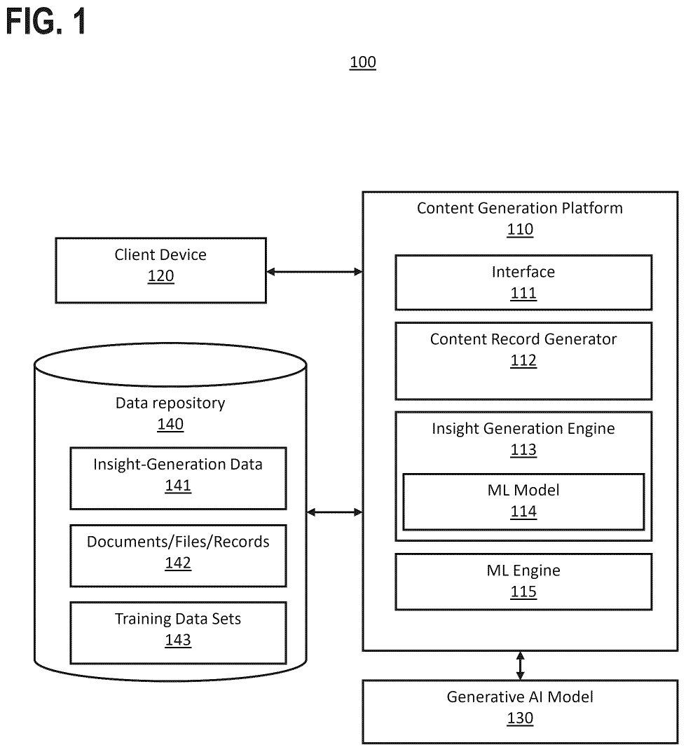

FIG. 1 illustrates a system 100 in accordance with one or more embodiments. As illustrated in FIG. 1, system 100 includes a content generation platform 110, a client device 120, a generative AI model 130, and a data repository 140. In one or more embodiments, the system 100 may include more or fewer components than the components illustrated in FIG. 1. The components illustrated in FIG. 1 may be local to, or remote from, each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

In one or more embodiments, a data repository 140 is any type of storage unit and/or device (e.g., a file system, database, collection of tables, or any other storage mechanism) for storing data. Further, a data repository 140 may include multiple different storage units and/or devices. The multiple different storage units and/or devices may or may not be of the same type or located at the same physical site. Further, a data repository 140 may be implemented or executed on the same computing system as the content generation platform 110. Additionally, or alternatively, a data repository 140 may be implemented or executed on a computing system separate from the content generation platform 110. The data repository 140 may be communicatively coupled to the content generation platform 110 via a direct connection or via a network.

Information describing the insight-generation data 141, the documents, files, or records 142, and the training data sets 143 may be implemented across any of components within the system 100. However, this information is illustrated within the data repository 140 for purposes of clarity and explanation.

A client device 120 interacts with the content generation platform 110 to generate and modify documents, files, and records 142. The content generation platform 110 includes an interface 111 to allow a user to view and modify documents, files, and records via the client device 120. In one or more embodiments, interface 111 refers to hardware and/or software configured to facilitate communications between a user and the content generation platform 110. Interface 111 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 111 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 111 is specified in one or more other languages, such as Java, C, or C++.

In one embodiment, the content generation platform 110 includes a content record generator 112. The content record generator 112 transmits data for displaying a GUI to the client device 120 via the interface 111. The GUI allows a user to create and arrange content, such as text, graphics, tables, and pictures, that may be stored as a document or file. For example, the GUI may allow a user to create and arrange content to be stored in a word processing file. As another example, the GUI may allow a user to create and arrange content to be stored as a webpage. The GUI includes different regions for displaying different types of data. One region is referred to herein as a data display region. In one or more embodiments, the data display region of the GUI displays data associated with one or more topics. For example, the data display region may display data for a document. One section of the document may pertain to one topic. Another section may pertain to another topic. The data display region displays a data set including text, graphics, graphs, and pictures that may be stored as documents, files, or records 142. A user interacts with the GUI to add, remove, and modify the data set presented in the data display region. The user may instruct the content generation platform to store the data set in the data display region as a document, file, or record 142.

Another region of the GUI is a target region. The target region may include, for example, windows or panels that are configured to receive a user input for generating content in the target region. Based on further user input, the system may subsequently incorporate the content from the target region into the data set displayed in the data display region. For example, a user may enter text into a target region. While the text is in the target region, the system may prompt the user to modify the text. For example, the system may ask the user whether to add one or more sentences, charts, or images to the content displayed in the target region. Based on a further user input, the system may transfer text that is displayed as content in the target region into the data set of the data display region. As another example, a user may drag and drop interface elements displayed in the GUI into a target region. The system may generate content in the target region based on the interface element dragged and dropped into the target region. Upon receiving an additional user input, the system may incorporate the content displayed in the target region into the data set displayed in the data display region.

In one embodiment, the content generation platform 110 interacts with a generative artificial intelligence (AI) model 150 to generate content in the data display region and the target region. For example, a user may access the content record generator 112 to upload a template report, such as a quarterly financial report. The content generation platform 110 presents the template report as a data set in the data display region. The content record generator 112 generates prompts to input to the generative AI model 150 to generate data to display in the different sections in the report. For example, the content record generator 112 may generate a prompt for a section entitled “cashflow trends” instructing the generative AI model 150 to generate a graph representing cashflow trends for the past year. Additionally, or alternatively, the content record generator 112 may generate a prompt directing the generative AI model 150 to generate a paragraph of text describing a set of cashflow trend data. The user may interact with the GUI to modify the data generated by the generative AI model 130 in the data presentation region of the GUI.

Another region in the GUI is an insight-presentation region. The insight-presentation region displays insights generated by an insight generation engine. The insight generation engine 113 generates insights associated with the data set in the data display region of the GUI. The insight generation engine 113 generates the insights based on attributes of the data set including key words, topics, underlying documents and files used to generate the data set, and documents and files related to the data set, such as topically related to the data set. For example, if a section in the data display region is entitled “Company Growth This Year,” the insight generation engine 113 may generate an insight indicating that “25% of the company growth is in foreign markets.” The insights may highlight information that is relevant to the data set presented in the data display region, and which is not already displayed in the data display region.

In one or more embodiments, the insight generation engine 113 generates insights based on applying data presented in the data display region to a machine learning model 114 trained by a machine learning engine 115. The insight generation engine 113 may further apply additional data to the machine learning model 114. Additional data may include, for example, underlying data, such as documents and files, from which the data set is obtained and/or generated, and metadata specifying attributes of the data set, such as a user that generated the data, a time when the data was generated, and individuals or organizations to whom the data set is directed.

The machine learning engine 115 trains the machine learning model 114 based on a machine learning algorithm. The machine learning algorithm is an algorithm that can be iterated to train a target model f that best maps a set of input variables to an output variable, using training data sets 143. The training data includes datasets and associated labels. The training data sets 143 include historical content from the data display region of the GUI and historical insights presented with the historical content. The training data sets 143 may further include historical selection data indicating whether a particular insight was selected by a user to generate content for inclusion in the data set displayed in the data display region. The training data sets 143 are associated with input variables for the target model f. The input variables include data displayed in the data display region, such as key words, topics, semantic data associated with the content in the data display region, selection data (e.g., whether, and how frequently, insights are selected for inclusion in the data display region), and content types (such as text, graphics, and pictures). The associated labels are associated with the output variable of the target model f. The output variable may include a binary value indicating whether a particular insight was selected for inclusion in a particular set of historical data. Additionally, or alternatively, the output variable may include a value among a range of values representing an importance of an insight to a set of data displayed in the data display region. The training data may be updated based on, for example, feedback on the predictions by the target model f and accuracy of the current target model f. Updated training data is fed back into the machine learning algorithm, which in turn updates the target model f.

A machine learning algorithm may include supervised components and/or unsupervised components. Various types of algorithms may be used, such as linear regression, logistic regression, linear discriminant analysis, classification and regression trees, naïve Bayes, learning vector quantization, support vector machine, bagging and random forest, boosting, backpropagation, and/or clustering. In an embodiment, the machine learning algorithm is iterated to learn what data should be used to generate insights.

In one or more embodiments, the machine learning model 114 includes an encoder-type model to generate embeddings of data set content displayed in the data display region and embeddings of words, phrases, sentences, and excerpts from content in documents, files, and records 142. The model identifies a relationship between the embeddings of the data set content and the embeddings of content in the documents, files, and records 142. For example, the model may identify a similarity among two or more different embeddings. The system generates the insights based in part on the relationship between the embeddings of the data set content and the embeddings of content in the documents, files, and records 142.

The content record generator 112 displays insights in an insight-presentation region of the GUI. When the content record generator 112 stores the content as a document, file, or record 142 the insight presentation region is not stored together with the content in the file. For example, if the content in the data display region of the GUI corresponds to a report, the content record generator 112 stores the report as a digital file 142 without storing any insights that are displayed in the insight presentation region.

The insight generation engine 113 stores insight generation data 141. The insight generation data 141 includes data used to generate the insights. For example, the insight generation engine 113 may analyze and/or apply the machine learning model 114 to reports (such as production reports, sales reports, project progress reports), transaction data, system logs, articles (such as industry-specific articles and news articles), and any other type of data identified by the content generation platform 110 as being relevant to documents, files, and records 142 generated by the content record generator 112.

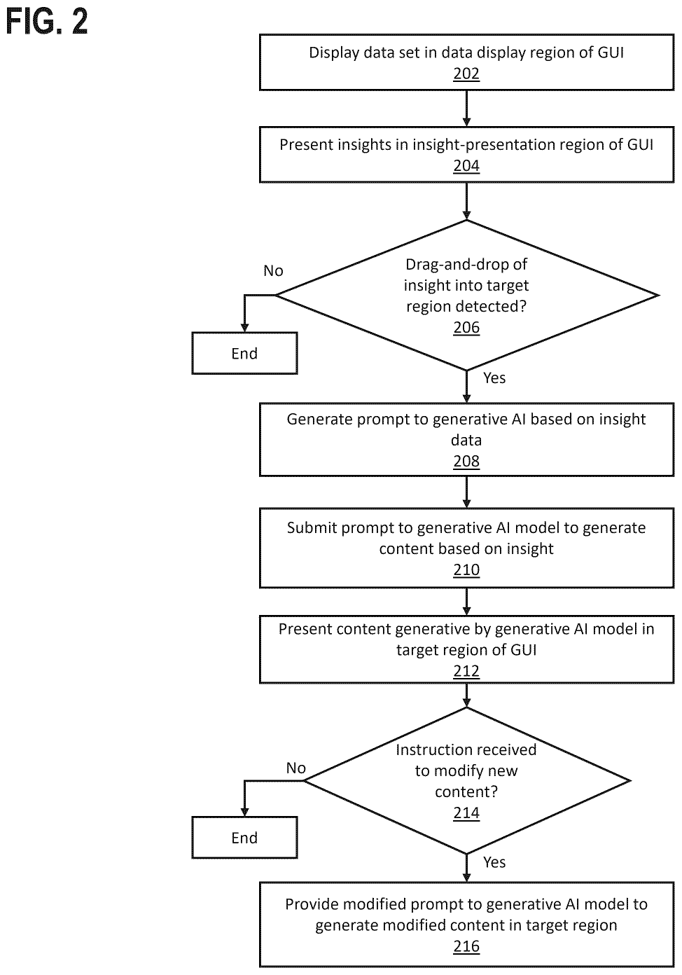

In one or more embodiments, the content generation platform 110 refers to hardware and/or software configured to perform operations described herein for the content generation platform 110. Examples of operations for the content generation platform 110 are described below with reference to FIG. 2.

In an embodiment, the content generation platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. APPLYING A GENERATIVE AI MODEL TO GENERATE CONTENT

FIG. 2 illustrates an example set of operations for generating content in a graphical user interface (GUI) based on inputting insight data to a generative AI machine learning model in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

In an embodiment, the system displays a data set in a data display region of a graphical user interface (GUI) (Operation 202). The GUI is partitioned into multiple regions including at least a data display region, an insight presentation region, and a target region. In one example, the data display region is a region in which a user may specify content to display in a digital document. For example, the data display region may display content to be included in a report in a digital document. As another example, the data display region may display content to be included in a webpage.

The GUI includes at least one target region. In one example embodiment, target regions include content entry fields that are arranged above, below, or alongside, the data displayed in the data display region. For example, the GUI may present, in descending order, two text paragraphs, a content entry field associated with the two text paragraphs, a diagram, and another content entry field associated with the diagram. The content entry fields may be presented as windows in the GUI into which a user may type content or drag-and-drop displayed interface elements in the GUI to generate content. Based on subsequent user input, the system may incorporate content from the target regions into the data set displayed in the data display region.

According to one example, a system populates one or more portions of the data display region with data, such as text, pictures, tables, and graphics. The system further provides one or more target regions as content entry fields interspersed among the data presented in the data display region. The system may allow a user to modify the data displayed in the data display region. The system may further allow a user to generate new content in the content entry fields. The system may further allow a user to modify content that has been generated in a content entry field.

In one embodiment, the content entry fields are displayed with the data display region in a GUI that a user may use to generate content for a document or file. When the system stores the document or file, the system may store the data set displayed in the data display region without storing any content entry fields. In other words, the system displays the target regions as content entry fields for purposes of creating a document. When content is entered into the content entry fields, the system incorporates the content into the data set of the data display region. When the system stores the document, the system stores the document with the data displayed in the data display region, while omitting the display of any content entry fields.

In one or more embodiments, the GUI is implemented by a document- or file-generation platform. For example, the platform may provide a user interface to allow users to generate a word processing document, an image-type file, a webpage, or another type of file for displaying text content, as well as graphics and images. In a document or file creation stage, the platform presents the data display region, the insight presentation region, and the target region. In a document or file presentation stage, the platform may present the data display region. However, the platform may refrain from presenting the insight presentation region and the target region.

The system presents, in the insight presentation region, one or more insights associated with the content that is in the data display region (Operation 204). In one or more embodiments, the insights represent information that is related to the content in the data display region. The insights are selectable by a user to generate new content to include in the data display region.

In one embodiment, the system identifies topics associated with the content in the data display region by analyzing one or more of headers in the data display region, body paragraphs in the data display region, and metadata associated with the data display region. For example, the system may apply a semantic analysis type machine learning model to the content in the data display region to identify main ideas of sentences, paragraphs, and groups of paragraphs. In addition, or in the alternative, the system may identify key words and/or section headers.

In one embodiment, the system inputs data presented in the data display region associated with the content located in the data display region to a trained machine learning model that is trained to generate one or more insights. The system may train the machine learning model based on a training data set including historical data displayed in the data display region, historical insights presented alongside the historical data, and metadata associated with the data display region data and the insights The documents or records that make up the data set may further include labels indicating a value for the presented insight. For example, if an insight was historically selected by a user, the system may assign a high ranking to the insight. If the insight was not historically selected by the user, the system may assign a low ranking to the insight. The label may be a binary value (e.g., 1 or 0) or a scaled ranking (e.g., between 1-10). The training data set may further be labeled with labels representing a relevance of an insight to the presented based content or an importance of the insight. For example, the system may assign a high value to an insight representing a critical error in a system that may adversely affect operations of the system. The system may assign a low value to an insight representing a non-critical error in a system that would not adversely affect operations of the system.

In one embodiment, the system generates insights based on data stored and/or maintained by an entity. For example, a company may subscribe to, or maintain, a cloud-based file storage service. An employee of the company may log in to the cloud-based service to generate a report and to store the report as a file. The platform may generate insights for the report based on documents and files stored and maintained by the company in one or more servers accessible via the cloud-based service. The documents and files stored and maintained by the company are differentiated from documents and files that are available to any user of a wide-area network, such as an individual performing a search on the Internet.

The system detects a selection of a particular insight among a set of presented insights (Operation 206). In one embodiment, the system detects a drag-and-drop operation in which a user selects a representation of an insight in the GUI and drags the representation of the insight into a content entry field in the data display region. Alternatively, a user may select an insight based on a double-click type operation in the GUI or a selection of a pop-up menu item. For example, the system may display a selectable icon in the representation of the insight. Based on a user selecting the icon, the system may generate a set of menu items. One of the menu items may be to “generate document content.”

According to one embodiment, the system displays multiple target regions and multiple data display regions in a GUI. For example, the system may display multiple content-entry fields (e.g., target regions) interspersed among text paragraphs (e.g., data display regions). The text paragraphs may correspond to different topics. For example, a document generator application may populate a GUI with paragraphs that correspond to headings “Profitability,” “Supply Chain,” and “Challenges Ahead.” The application may display in the GUI a separate content-entry field associated with each respective heading and set of paragraphs. Detecting the selection of a particular insight may include detecting that a user dragged an insight icon in the GUI into one of the content-entry fields.

The system generates a prompt to input to the generative AI model based on the insight data (Operation 208). The system obtains a set of prompt data for generating a machine learning prompt to input to a generative artificial intelligence (AI) model to generate content. In one embodiment, obtaining the prompt data includes extracting key words and phrases from the selected insight, extracting key words and phrases from content included in the data display region of the GUI, obtaining metadata associated with the selected insight, and accessing underlying source documents, files, and content associated with one, or both, of the content in the data display region and the selected insight.

For example, the system may present an insight with the text “Predicted shortage of 1,000 units in Q3.” Based on detecting a user operation to drag-and-drop the insight into a content generation field, the system may generate a prompt including text from the insight and an instruction to “provide further explanation.” Additionally, or alternatively, the system may obtain metadata stored with the insight that identifies the source documents and/or files from which the insight was generated. For example, the files may include a series of production reports. The system may obtain from the source documents and files additional data associated with the insight, such as trend data including inventories in the previous three quarters, prediction data for the inventories in the subsequent three quarters, raw numbers of units produced, units sold, and predicted demand, and information associated with root causes of the shortage, such as materials required to produce units and manpower required to produce the units.

The insight data used to generate the prompt for the generative AI model may include (a) content included in the insight, (b) content included in the data display region of the GUI, and (c) additional information associated with the insight and the data display region of the GUI that is not presented in the insight or the data display region. The system may identify documents, files, or records that were used by a generative AI model to generate one or both that data set displayed in the data display region and the insight. In addition, the system may identify additional documents, files, and records that were not used to generate the data set displayed in the data display region or the insight, but which the system determines are relevant to the displayed data set or the insight. The system may extract from source documents, files, and/or records additional information such as geographical information associated with insight, organizational information associated with an organization related to the insight, and information about projects in an enterprise that are related to the insight.

In one embodiment, the system obtains data from the data display region to include in the input to the generative AI model. For example, the data display region may include a header—“Southeast Region”—and content describing production statistics in the Southeast region for an enterprise. The system may include the geographic data “southeast region” with the insight data associated with the predicted shortage of 1,000 units in the third quarter, to the generative AI model. In addition, or in the alternative, the system obtains historical user data, such as historical user interactions with the displayed data set and with other displayed data sets. The historical user data may include text, graphics, and other data that a user has added to data sets. Additionally, or alternatively, the system may obtain historical user data of other users, other than the user presently viewing the data set. For example, the system may determine that a present user is a team managers. The system may obtain historical user data of the interactions of other team managers with data sets. For example, if the displayed data is a draft report, the system may obtain historical data of other team managers with other draft reports.

Generating the prompt for the generative AI model may include, for example, few-shot prompting, prompt engineering, and prompt tuning. For example, the system may engineer a prompt including one or more fixed parameters and one or more variable parameters. For example, the prompt may include fixed parameters to generate output content of a fixed length, or within a fixed range, such as 3-5 sentences. The prompt may include variable parameters for source documents to be used to generate the content, a topic for the content, and a geographic region associated with the content. As an example, a prompt may specify the following: “generate a paragraph including between 3-5 sentences describing the shortage of 1,000 units in the third quarter in the Southeast Region as described in documentXYZ.” Similarly, the system may engineer a prompt including the following parameters: generate a graph depicting the trends in unit production over a period of time including 3 months prior to the third quarter and two months after the third quarter based on the production data in productiondatafileA, productiondatafileB, and productiondatafileC.” As another example, the system may engineer a prompt to include the following parameters: “Summarize the following content into two paragraphs describing the shortage of 1,000 units in the third quarter [insert content from unit production reports identified from insight metadata].” The system transmits the prompt to the generative AI model.

In one or more embodiments, the generative AI model is a large language model (LLM). In one or more embodiments, the LLM is a type of deep learning model that combines a deep learning technique, called attention, with a deep learning model type, known as transformers, to build predictive models. These predictive models encode and predict natural language writing. The LLM contains hundreds of billions of parameters trained on multiple terabytes of text. The LLM is trained to receive natural language as an input. LLMs typically generate natural language as an output. In addition, the LLM is trained to output computer code. The LLM is made up of layers of attention mechanisms and neural networks that process input data in parallel. The layers of attention mechanisms and neural networks operating in parallel allow the LLM to learn complex patterns in text and code.

The attention mechanisms help neural networks to learn the context of words in the sequences of words. In the LLM, the attention mechanisms help neural networks to learn the context of words, symbols, and other tokens in computer code among sequences of computer code. An attention mechanism operates by breaking down a set of input data, such as a sentence or sequence of words or tokens, into keys, queries, and values. Keys represent elements of the input data that provide information about what to pay attention to. Queries represent elements of the input data that need to be compared with the keys to determine relevance. Values are elements of the input data that will be selected or weighted based on the attention scores. The attention mechanism calculates a similarity score between each query and key pair. This score reflects how relevant a key is to a given query. Various methods can be used to compute these scores, such as dot-product, scaled dot-product, or other custom functions. The similarity scores are then transformed into attention weights. For example, a system may transform the similarity scores using a softmax function. The softmax function adjusts the values of the similarity scores relative to each other such that the sum of the similarity scores is 1. Finally, the attention weights are used to take a weighted sum of the corresponding values. This weighted sum represents the model's focused or “attended” representation of the input data. In one or more embodiments, the attention mechanisms are implemented using self-attention processes, scaled dot-product attention processes, and multi-head attention processes.

In an operation, the LLM receives a natural language prompt as input data and generates a sequence of words in natural language by predicting a next word, or sequence of words, based on the textual and grammatical patterns learned by the LLM during training. The LLM is trained on a broad dataset. In one example embodiment, the broad dataset may include widely available documents and records, such as webpages available on the Internet. The broad dataset may exclude proprietary documents and files stored in a proprietary data storage system. The system may generate the insights based on the proprietary documents and files stored in the proprietary data storage system. Examples of proprietary documents and files include company-generated statistics, company-maintained reports, and other company-stored data. In one embodiment, the system generates a prompt to instruct the LLM to generate content in a target region by including in the prompt at least an excerpt of text from a proprietary document or file from the proprietary file storage system.

The system submits the prompt to the generative AI model to generate content based at least on the insight (Operation 210). For example, a data set in a data display region may include data describing revenue for a particular company in various geographical regions. An insight may include the following text: “Shortage of 10,000 units.” The system may generate the insight by analyzing proprietary reports stored in company's proprietary data storage system. Based on a user operation to drag the insight into a target region of the GUI, the system may generate the following prompt: “Generate text including a header and 2-3 sentences based on the document SupplyReportABC,” that the system identified as the report in the proprietary data storage system from which the insight was generated. The system submits the prompt and the report to the generative AI model. The generative AI model generates a set of content: “Production in the third quarter was limited to 90,000 units due to battery supply shortages. This is 10,000 units short of the 100,000 production orders.”

The system displays the content generated by the generative AI model in the target region of the GUI (Operation 212). The content may include, for example, text content, graphs representing data, pictures, and other graphics. The system may present the content inside the content entry field in which a user dragged-and-dropped an insight. Responsive to another user input, such as accepting generated content, the system may transfer new content generated by the generative AI model responsive to the user's drag-and-drop operation from the target region into the data display region. Alternatively, the system may generate the content directly in the data display region in response to detecting the user operation to drag-and-drop an insight into the target region. For example, the system may present a content-entry field at the bottom of the data display region. A user may add content to the data display region by dragging a representation of an insight into the content-entry field.

The system determines whether a selection has been detected to modify the content generated by the generative AI model (Operation 214). For example, once the system has displayed the new content generated by the generative-AI model, the system may display a prompt in the GUI for a user to modify the content. In one example, the system presents the new content generated by the generative-AI model in a content-entry window. The system presents a text-entry field at the bottom of the content-entry window. A user may enter text into the text-entry window field to generate instructions for modifying the content generated by the generative-AI model. Examples of instructions may include “generate a diagram representing these paragraphs,” “generate a new set of content including 5 paragraphs,” and “generate new content that also includes a forecast of the production for the next quarter.”

Based on detecting a user selection to modify the content generated by the generative AI model, the system inputs a new set of prompt data to the generative AI model to generate a new set of content (Operation 216). The new set of prompt data may include, for example, the original prompt data and modification data. The system may identify the modification data based on user-entered text. For example, a user may enter text directing the generative AI model to “tell me more about downstream effects of the shortage,” “what is the financial cost of the shortage,” or “how long is the shortage predicted to last?” Based on the user-entered text, the system may identify any data associated with the user-entered text. The system may include the data in the new prompt for the generative AI model.

### 4. EXAMPLE EMBODIMENT

A detailed example is described below for purposes of clarity. Components and/or operations described below should be understood as one specific example which may not be applicable to certain embodiments. Accordingly, components and/or operations described below should not be construed as limiting the scope of any of the claims.

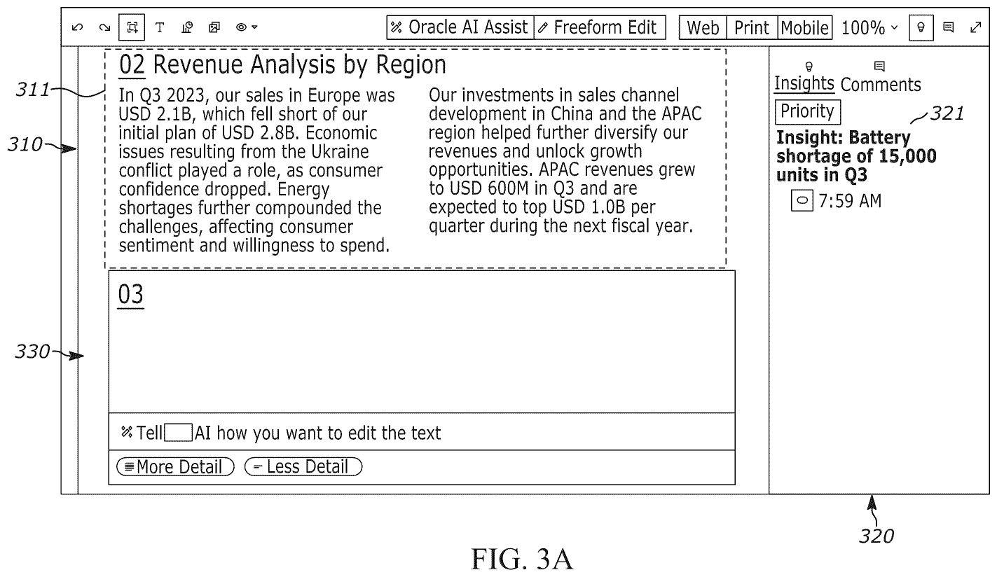

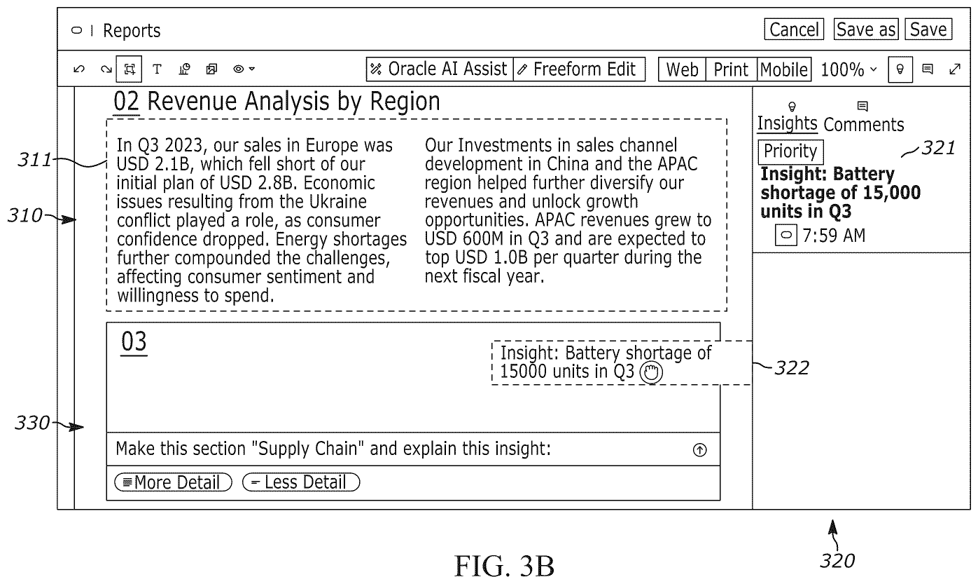

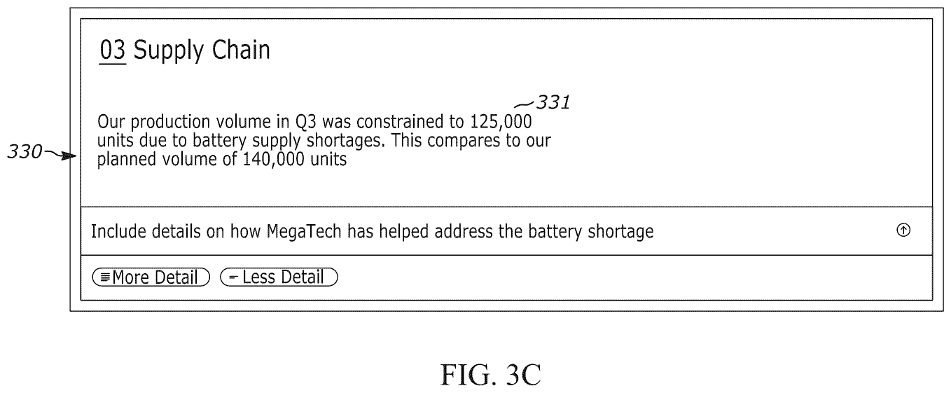

As illustrated in FIG. 3A, a system presents a graphical user interface (GUI) including a first region 310, a second region 320, and a third region 330. The first region 310 is a data display region that displays a data set 311 associated with the topic “Revenue Analysis by Region.” The second region 320 is an insight display region. The second region 320 presents insights 321 based on the content in the first region 310. The system trains a machine learning model with a training data set that includes (a) content in the first region, (b) presented insights, and (c) insights that were historically selected by a user for inclusion in the data display region 310 or the third region 330. The training data set may also include enterprise data associated with the content in the first region. For example, if the first region 310 includes data about a revenue-by-region metric for an enterprise, the training data may include sales and production data, including historical sales, historical production, cost data, and predictions for future sales, production, and costs.

According to the example illustrated in FIG. 3A, a machine learning model generates a set of embeddings representing the content in the first region 310. An example of a set of features included in the embedding may be “revenue, region, 3^{rd} quarter 2023, China, . . . ” The system further embeds enterprise data. The machine learning model identifies enterprise data embeddings that (a) relate to the embedding for the content in the first region 310, and (b) based on the model's training are determined to be likely to be interesting to the user.

The system displays one or more insights in the second region 320 based on the content included in the first region. The system may present the insights based on recommendations from the machine learning model. The system may present the insights based on a combination of (a) an insight-identification model that generates insight predictions based on enterprise data and (b) an AI-type content-generation model that receives data from the insight-identification model as a data prompt to generate content for the insight. For example, the insight-identification model may generate an insight embedding that represents the semantic content of an insight. The system may prompt a generative AI model to generate an insight in human-understandable language. For example, the prompt may include the instruction: “Generate a one-sentence summary for the attached embedding.” The system may present the insight 321 in the insight-presentation region 320.

The third region 330 is a target region. In the example embodiment of FIG. 3A, the third region 330 is a region configured to receive user input to add and/or modify content in the target region. The system subsequently incorporates the content generated in the target region into the first region 310.

As illustrated in FIG. 3B, a user drags-and-drops the representation 322 of the insight 321 in the GUI from the second region 320 into the content generation field in the first region 310 of the GUI. Based on the drag-and-drop operation, the system transmits the insight to a generative AI model to generate one or more paragraphs, diagrams, and pictures representing the insight in the first region of the GUI. The system may identify text within the graphical representation of the insight. The system may further identify metadata associated with the graphical representation of the insight. Metadata may include stored values on which the insight is based. For example, if the insight indicates a battery shortage is projected in the third quarter, the metadata may identify one or more tables storing information about prices for battery components, inventory data, and historical sales of batteries.

As illustrated in FIG. 3C, the system presents content 331 in the target region 330 based on content generated by providing the insight data to a generative AI model. The insight data, including any backend metadata that is used to generate the insight, is used as a prompt to prompt the generative AI model to generate the content. As illustrated in FIG. 3C, the content 331 is a set of private data for an enterprise that would not be among a set of records used to train a generative AI model. For example, a generative AI model would not be trained to include a third-quarter report for a battery supplies for a company. Instead, the content 331 is generated based on data stored in a private data management system of an enterprise. In addition, the insight 321 illustrated in FIG. 3B may be a summary of a set of stored data. The content 331 may include additional details associated with an event, system, or value identified in an insight 321. In addition, the content 331 may also be a summary of a stored set of data. Alternatively, the content 331 may be an extrapolation or expounding of a set of stored data. For example, a report stored in a data system may include information “Q3” and “125,000 units.” Another document may describe a battery supply shortage, without describing specific numbers. The system may prompt the generative AI model with embeddings representing excerpts from both documents. The generative AI model may generate a human-understandable paragraph, illustrated in FIG. 3C, from the raw report data.

According to one or more embodiments, the target region 330 includes a “more detail” user interface button and a “less detail” user interface button. Once the system has presented the content 331 generated by the generative AI model, the user may select the “more detail” button to modify the content 331. In particular, when the user selects the “more detail” button, the system generates a prompt for the generative AI that includes the content from the original prompt (such as the insight data 321 and the displayed data 311) as well as an instruction to include more data in the generative AI output. For example, the system may include an instruction in the prompt to “generate three sentences.” Additionally, or alternatively, the system may include an instruction in the prompt to “include a link to a source document.” Conversely, if a user selects the “less detail” user interface icon, the system may generate the prompt with an instruction to “generate a one-sentence description.”

### 5. PRACTICAL APPLICATIONS, ADVANTAGES, AND IMPROVEMENTS

One or more embodiments are implemented in a platform for generating and presenting digital content. A platform includes a content-generation and modification GUI that allows users to generate digital content. The platform may store the generated digital content in a digital file. The file may be subsequently viewed and modified. Examples of content-generation platforms include applications for generating reports, generating webpages, generating slides, and generating word-processing documents.

One or more embodiments apply a machine learning model to generate and present insights alongside user-generated content. Insights include contextual data that relates to the user-generated content. The machine learning model may generate embeddings of displayed data and/or metadata associated with the displayed data. The machine learning model may further generate embeddings of stored data, such as company reports. The machine learning model may identify insights based on determining a similarity between the embeddings of displayed content and the stored content. Embodiments improve the technology of automating and customizing digital document generation by applying machine learning technology to sets of data associated with digital content, such as proprietary or private data for a company. The machine learning model applies encoding and embedding techniques to generate user interface insights from the proprietary and/or private data for the company. The user interface insights are selectable by users to generate additional content in a user interface.

One or more embodiments further improve digital content generation methods and systems by applying a second type of model, such as a generative AI model, to generate the additional content. The platform modifies the conventional operation of a generative AI model by providing the insight and/or metadata associated with the insight to generate content that is based on the proprietary and/or private data. The ability to select an insight identified by machine-learning techniques to generate a prompt for a generative AI model to generate natural language content in a user interface improves the functioning of the digital content generation user interface. Conventional data management systems require users to master complex and potentially arbitrary data storage techniques and conventions. In addition, if a user is preparing digital content for a particular aspect of a particular entity (such as a product of a company), conventional content-generation systems require users to know or remember every relevant piece of information associated with the aspect and entity to generate the digital content. In embodiments, users are able to interact with an intuitive user interface to generate digital content without the need to master complex and arbitrary systems and methods for storing data and accessing stored data. For example, when a user is generating a report about a particular product, the user does not need to remember every event associated with the product, where information associated with the event is stored, and how to navigate a file storage system to access data associated with the product. Instead, the platform applies machine learning techniques to displayed data in a user interface to generate insights in the user interface which a user may select to generate digital content in the report based on the stored content without even requiring the user to navigate to the stored content.

One or more embodiments generate insights from proprietary content, such as private company documents and reports that are not published on the Internet. The system includes interface elements in the GUI to allow the user to prompt a generative AI model to generate content from the insights. The generative AI model may be trained on publicly-available data, such as documents published on the Internet. The system instructs the generative AI model to incorporate privately-stored data into generated content by including metadata, embeddings, or excerpts from the privately-stored data associated with the insight in the generative AI prompt. By providing an intuitive user interface to incorporate system-generated insights (and underlying document data) in generative AI prompts, the system allows users to generate customized content using proprietary or private data, without requiring users to (a) be aware of all the stored private data, or (b) know where to find all the stored private data. In addition, the intuitive UI allows the user to apply generative AI models to generate human-understandable content from privately-stored data. Applying insights as prompt data to the generative AI model, the system improves conventional content-generation methods by providing a way for generically-trained models to include data from proprietary or private data storage systems without the need to retrain the generative AI model with the proprietary or private data storage system.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

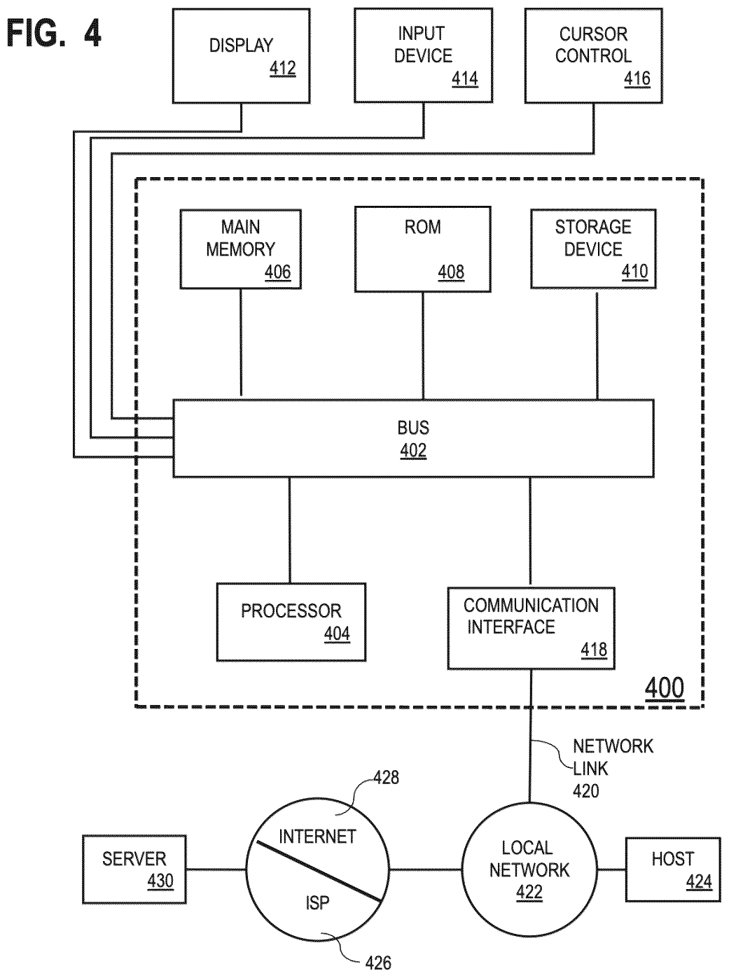

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid-State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
presenting a data set in a first region of a graphical user interface (GUI);
presenting a set of insights associated with the data set in a second region of the GUI;
receiving a first user input dragging a particular insight from the set of insights presented in the second region of the GUI into a third region of the GUI;
responsive to the first user input dragging the particular insight into the third region of the GUI:
inputting the particular insight to a generative AI model to generate first content corresponding to the particular insight for the data set; and
presenting the first content within the GUI.

2. The one or more non-transitory computer readable media of claim 1, wherein the third region is selected from among a plurality of third regions displayed in the GUI, and
wherein presenting the first content within the GUI includes displaying the first content in the third region.

3. The one or more non-transitory computer readable media of claim 1, wherein the operations further comprise applying a machine learning model to the data set to generate the one or more insights.

4. The one or more non-transitory computer readable media of claim 3, wherein the operations further comprise:
training the machine learning model to generate insights at least by:
obtaining historical data comprising historical data sets;
generating a training data set comprising:
the historical data sets;
features of the historical data sets; and
insight data for the historical data sets, wherein the insight data comprises one or more of events associated with the historical data sets, one or more feature values associated with the historical data sets, and one or more predictions associated with the historical data sets; and
applying the training data set to the machine learning model to iteratively adjust parameters of the model to generate a trained machine learning model to generate the insights by predicting a particular insight for a particular data set.

5. The one or more non-transitory computer readable media of claim 1, wherein presenting the first content within the GUI comprises presenting the first content within the same third region of the GUI corresponding to the user input.

6. The one or more non-transitory computer readable media of claim 1, wherein inputting the particular insight and the data set to the generative AI model comprises:
obtaining metadata from the particular insight to access a particular set of insight data based on the particular insight; and
generating a prompt to input to the generative AI model based on the set of insight data.

7. The one or more non-transitory computer readable media of claim 1, wherein the data set includes text content in an electronic document, and
wherein the third region includes a field in the electronic document.

8. The one or more non-transitory computer readable media of claim 1, wherein the operations further comprise:
subsequent to presenting the first content within the GUI, receiving a second user input to modify the first content;
responsive to receiving the second user input:
inputting at least the first content and a set of content-modification data based on the second user input to the generative AI model to generate second content; and
replacing, in the GUI, the first content with the second content.

9. A method comprising:
presenting a data set in a first region of a graphical user interface (GUI);
presenting a set of insights associated with the data set in a second region of the GUI;
receiving a first user input dragging a particular insight from the set of insights presented in the second region of the GUI into a third region of the GUI;
responsive to the first user input dragging the particular insight into the third region of the GUI:
inputting the particular insight to a generative AI model to generate first content corresponding to the particular insight for the data set; and
presenting the first content within the GUI.

10. The method of claim 9, wherein the third region is selected from among a plurality of third regions displayed in the GUI, and
wherein presenting the first content within the GUI includes displaying the first content in the third region.

11. The method of claim 9, further comprising applying a machine learning model to the data set to generate the one or more insights.

12. The method of claim 11, further comprising:
training the machine learning model to generate insights at least by:
obtaining historical data comprising historical data sets;
generating a training data set comprising:
the historical data sets;
features of the historical data sets; and
insight data for the historical data sets, wherein the insight data comprises one or more of events associated with the historical data sets, one or more feature values associated with the historical data sets, and one or more predictions associated with the historical data sets; and
applying the training data set to the machine learning model to iteratively adjust parameters of the model to generate a trained machine learning model to generate the insights by predicting a particular insight for a particular data set.

13. The method of claim 9, wherein presenting the first content within the GUI comprises presenting the first content within the same third region of the GUI corresponding to the user input.

14. The method of claim 9, wherein inputting the particular insight and the data set to the generative AI model comprises:
obtaining metadata from the particular insight to access a particular set of insight data based on the particular insight; and
generating a prompt to input to the generative AI model based on the set of insight data.

15. The method of claim 9, wherein the data set includes text content in an electronic document, and
wherein the third region includes a field in the electronic document.

16. The method of claim 9, further comprising:
subsequent to presenting the first content within the GUI, receiving a second user input to modify the first content;
responsive to receiving the second user input:
inputting at least the first content and a set of content-modification data based on the second user input to the generative AI model to generate second content; and
replacing, in the GUI, the first content with the second content.

17. A system comprising:
at least one device including a hardware processor, the system being configured to perform operations comprising:
presenting a data set in a first region of a graphical user interface (GUI);
presenting a set of insights associated with the data set in a second region of the GUI;
receiving a first user input dragging a particular insight from the set of insights presented in the second region of the GUI into a third region of the GUI;
responsive to the first user input dragging the particular insight into the third region of the GUI:
inputting the particular insight to a generative AI model to generate first content corresponding to the particular insight for the data set; and
presenting the first content within the GUI.

18. The system of claim 17, wherein the third region is selected from among a plurality of third regions displayed in the GUI, and
wherein presenting the first content within the GUI includes displaying the first content in the third region.

19. The system of claim 17, wherein the operations further comprise applying a machine learning model to the data set to generate the one or more insights.

20. The system of claim 19, wherein the operations further comprise:
training the machine learning model to generate insights at least by:
obtaining historical data comprising historical data sets;
generating a training data set comprising:
the historical data sets;
features of the historical data sets; and
insight data for the historical data sets, wherein the insight data comprises one or more of events associated with the historical data sets, one or more feature values associated with the historical data sets, and one or more predictions associated with the historical data sets; and
applying the training data set to the machine learning model to iteratively adjust parameters of the model to generate a trained machine learning model to generate the insights by predicting a particular insight for a particular data set.
